(19) United States
(12) Patent Application Publication
(10) Pub. No.: US 2008/0217933 A1
(43) Pub. Date: Sep. 11, 2008

(54) Power Striker Arrangement

(75) Inventor: Oleg Kornev, Cedex (FR)

Correspondence Address: OSHA LIANG L.L.P., 1221 MCKINNEY STREET, SUITE 2800, HOUSTON, TX, 77010, US

(73) Assignee: Valeo Sicherheitssysteme GmbH, Erdweg (DE)

(21) Appl. No.: 11/630,163

(22) PCT Filed: Jun. 22, 2004
(86) PCT No.: PCT/EP04/51199

§ 371 Date: Dec. 3, 2007

(51) Int. Cl. E05B 15/02

(52) U.S. Cl. 292/341.16

(57) ABSTRACT

The invention relates to a power striker arrangement to engage a striker (2) with a claw of a latch to move the claw from a first position towards a second position, including at least an engine (3) connected with at least one actuator (4) to bring the striker (2) from an initial position to a position of engagement with the claw and to return the striker/claw unit from the position of commitment of the striker (2) towards the initial position of the striker (2), characterized in that it includes a means for energy storage/release (1) capable of storing the energy during the course of the striker (2) from its initial position towards its position of commitment and of releasing this energy during the course of the striker/claw unit from the position of commitment of the striker (2) towards the initial position of the striker (2).

The invention relates to a power striker arrangement to urge a striker with a claw in order to move the claw from a first position towards a second position. It applies, in the automotive field, in particular to locks of the opening such as a trunk, a tailgate or a sliding side door, comprising one or two closing notches to assist closing in the phase of compression of the seal of the opening.

A power striker is a known device of previous art. This device is used to help with the closing of the opening thanks to the motorization of a mobile striker coming to engage a claw, by means of an engine connected to an actuator means making it possible to draw on the striker/claw unit to help, or assist, with the closing of the opening. These devices must be small because the place, which is allocated to them, is extremely reduced. Moreover, the actuator means and its engine must be sufficiently powerful for on the one hand ensuring the pulling of the opening which is often rather heavy and on the other hand to overcome the resistance of the seals of the opening and the friction forces of the system. Lastly, they must be the least noisy as possible.

One proposed in the previous art some improvements for the devices of power striker to assist, or help, the user to close the opening. Thus, one knows patents WO 9722771 and WO 9742384 which reveal devices in which the power striker is suited, thanks in particular to a spring, to make pass the connection striker/claw from the first safety notch to the second closing notch.

Nevertheless, this type of devices presents certain disadvantages.

Indeed, in these devices, it is necessary to use an engine of great power, and thus expensive and/or bulky, to make it possible to draw the striker/claw unit, once the striker is engaged in the claw.

The invention aims at curing this disadvantage by providing a mechanical means, inexpensive and not very bulky, ready to accumulate energy at the time of the phase of spacing, or moving, the striker, by means of the actuator means, and to release this energy at the time of the phase of return of the striker/claw unit, this phase requiring the maximum power and energy for the engine and actuator means.

Thus, the object of the present invention is a power striker arrangement to engage a striker with a claw of a latch to move the claw from a first position towards a second position, including at least an engine connected with at least one actuator to bring the striker from an initial position to a position of engagement with the claw and to return the striker/claw unit from the position of commitment of the striker towards the initial position of the striker, characterized in that it includes a means for energy storage/release capable of storing the energy during the course of the striker from its initial position towards its position of commitment and of releasing this energy during the course of the striker/claw unit from the position of commitment of the striker towards the initial position of the striker.

Thus, thanks to the device of the invention, it is now possible to obtain a greater force of pulling of the striker/claw unit, while preserving an engine of low dimension, power and noise. Indeed, thanks to the means for energy storage/release, the traction force of the striker/claw unit is increased up to 60%.

The invention also has the advantage of being able to adapt on the existing power strikers, without requiring structural modification or major modification.

According to an embodiment of the invention, the means for energy storage/release consists of a spring. So, the excess of energy supplied by the engine during the phase of bringing the striker from its initial position to its position of commitment is used to stretch the spring, thus storing some energy that will be restored during the phase of traction, or drive, of the striker/claw unit.

The invention is described below with more details, by means of drawings representing only favorite embodiment of the invention:

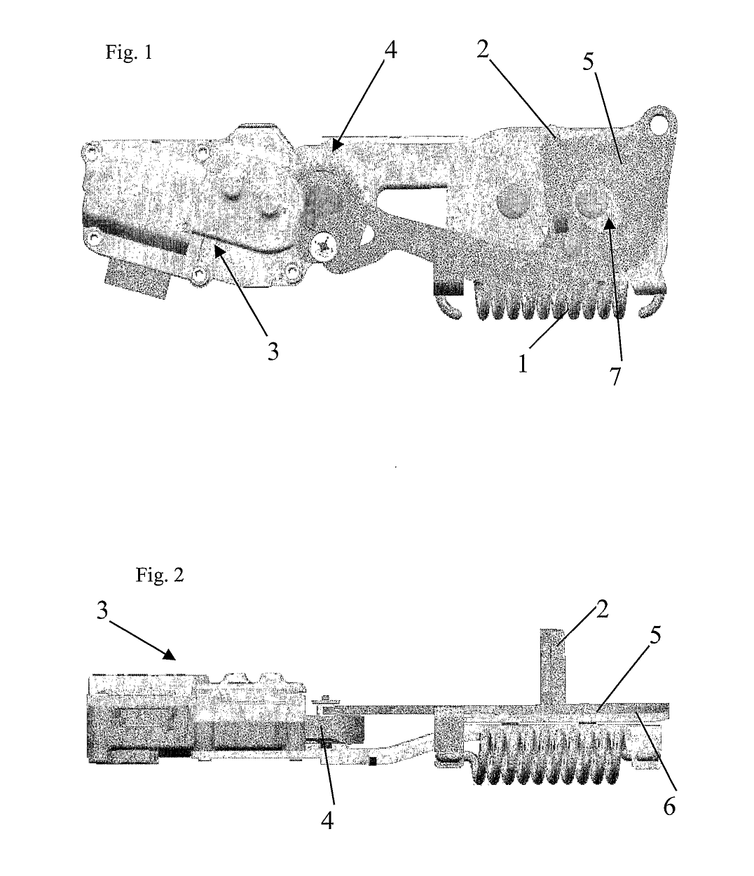

the FIG. 1 is a front view of an example of a power striker according to the invention.

the FIG. 2 is a bottom view of the device represented in FIG. 1.

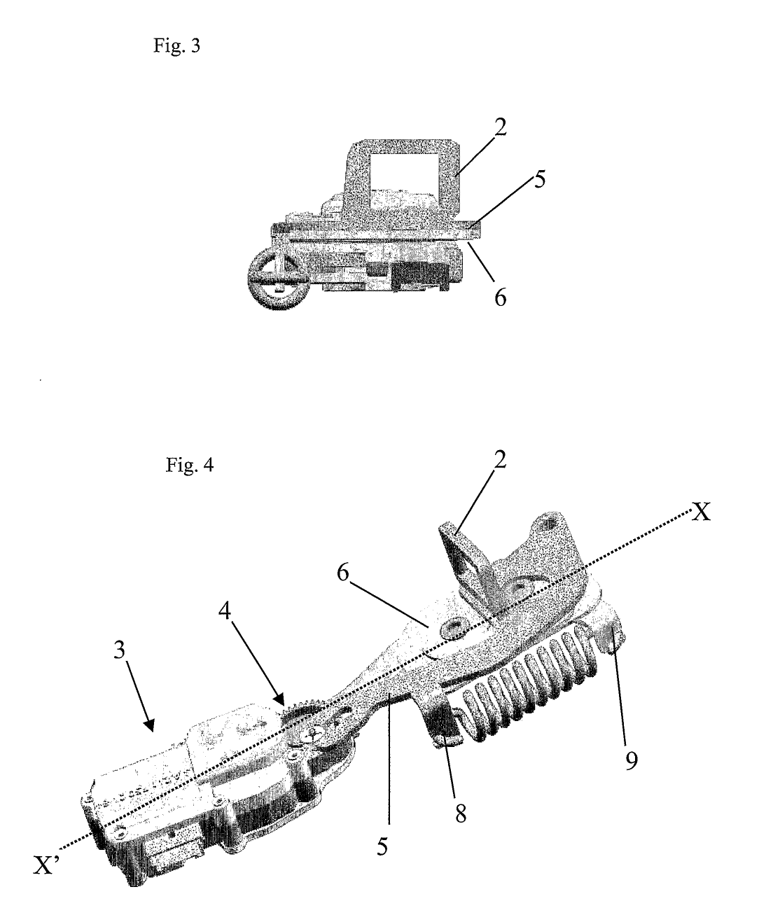

the FIG. 3 is a side view of the device represented in FIGS. 1 and 2.

the FIG. 4 is a view according to another angle of the device represented in FIG. 1 to 3.

In the present example of embodiment of the device according to the invention, the striker 2, the engine 3 and the actuator means 4 are fixed to the frame of the opening. Nevertheless, these elements 2, 3, 4 can also be situated on the opening and the claw on the frame of the opening, or door, frame.

The power striker arrangement includes, except the means for energy storage/release 1, all the usual elements of such a device known in the previous art.

So, this arrangement includes a striker 2 in shape of rectangle, either of U inverted, mobile between an initial position, or a low position, and a high position, or a position of commitment with the claw, which is not represented on the annexed figures. The position of the striker with regard to the commitment with the claw is classically determined by a switch, or a sensor, not represented, in a way that the engine 3 commands the return of the striker 2, that is the set striker/claw, by inversion of the rotation of the engine 3 in answer to a detection signal sent by the switch. Besides, the detection and the putting on of the power striker 2, and thus the rise of the striker from its initial position, or low, towards its high position, or of commitment with the claw, is realized in a classic way by means of sensors, such as described notably in U.S. Pat. No. 4,739,585, WO 9722771 or WO 9742384.

The striker 2 is fixed to a plate of mobile support 5 in rotation connected by one of its extremities with the actuator means 4, said means 4 being connected with the engine 3, and by its other extremity to a connection plate 6 fixed to a base plate, which is not represented on the annexed figures. The rotation of the mobile support 5 is made possible by means of a hole 7, extending substantially longitudinally, being present on the mobile support 5.

The spring 1 is affixed, at one of its extremities, to the connection plate 6 and at its other extremity, to the mobile support 5 to which is fixed the striker 2. Indeed, the plate of the mobile support 5 contains a lateral attachment 8, bent in an L shape, having a surface of grip/restraint to hang on it an extremity of the spring 1. In the same way, the connection plate 6 contains a lateral attachment 9, bent in an L shape, also having a surface of grip/restraint to hang on it the other extremity of the spring 1. So, the spring 1 is situated near the striker 2, more particularly bellow in the case the power striker 2 is mounted on the frame of a rear trunk of the motor vehicle. Besides, the axis of linear strain of the spring 1 is substantially parallel to the linear average axis X′ X of the plate of the mobile support 5.

The actuator means 4 is constituted here by a plurality of drive pinions meshing one with the others so as to act on the mobile support 5 to bring the striker 2 in its high position and return it to its initial, or rest, position.

In the example chosen to illustrate the invention, the spring 1 is chosen to produce a back force directed to the rest position, i.e. when the striker 2 is in its initial position. In the rest position, the spring shows a force of about 170 Newton (N), and produces a back force of about 370 N when the striker 2 is in its high position, while increasing in an approximately constant way during the passage of the striker 2 from its initial state to its extreme state of commitment with the claw. So, the back force of the spring 1 is more than doubled between both positions of the striker 2, initial and of commitment with the claw. Naturally, the stored and released energy will be chosen in accordance with specific requirements of the device and can easily vary for instance according to the length of the spring 1 or its coefficient of steepness.

To illustrate the invention, we choose to illustrate the example of a means for energy storage/release with a spring 1. Naturally, any device capable of performing the same function, namely the storage of energy during the phase of space, or move, of the mobile striker and the release of this energy to help in the drive, or traction, of the striker/claw unit, can be envisaged.

The spring can be for instance a rotational spring, a tension spring, a pressure spring, a cup/disk spring, a coil spring, a pneumatic spring, a ring spring, a plate spring or a variable-rate spring. In the same way, the spring can be constituted by any adequate material, notably a plastic and\or a metal, such as for example the steel.

The means for energy storage/release can also be integrated into the mobile support 5 to which is fixed the striker 2, for instance in the form of a spring. In this case, the mobile support 5 has both functions to move the striker and to help the set motor/actuator in the return phase, or back phase, of the striker/claw unit.

1. A power striker arrangement to engage a striker with a claw of a latch to move the claw from a first position towards a second position, including at least an engine connected with at least one actuator to bring the striker from an initial position to a position of engagement with the claw and to return the striker/claw unit from the position of commitment of the striker towards the initial position of the striker, characterized in that it includes a mechanical means for energy storage/release capable of storing automatically the energy during the course of the striker from its initial position towards its position of commitment and of releasing this energy during the course of the striker/claw unit from the position of commitment of the striker towards the initial position of the striker.

2. The power striker arrangement according to claim 1, characterized in that the striker, the engine and the actuator means are fixed to the frame of the opening.

3. The power striker arrangement according to claim 1, characterized in that the means for energy storage/release comprises a spring.

4. The power striker arrangement according to claim 3, characterized in the fact that the spring is affixed, at one of its extremities, to the connection plate and at its other extremity, to the mobile support to which the striker is fixed.

5. The power striker arrangement according to claim 3, characterized in that the spring is a rotational spring, a tension spring, a pressure spring, a cup/disk spring, a coil spring, a pneumatic spring, a ring spring, a plate spring or a variable-rate spring.

6. The power striker arrangement according to claim 4, characterized in that the means for energy storage/release is integrated into the mobile support.

7. The power striker arrangement according to claim 2, characterized in that the means for energy storage/release comprises a spring.
